(19) United States
(12) Patent Application Publication
(10) Pub. No.: US 2017/0274616 A1
(43) Pub. Date: Sep. 28, 2017

(54) SYSTEM AND METHOD FOR INDUCING FLUTING IN A PAPER PRODUCT BY EMBOSSING WITH RESPECT TO MACHINE DIRECTION

(71) Applicant: SCORRBOARD, LLC, RENTON, WA (US)

(72) Inventor: Giles GREENFIELD, Renton, WA (US)

(21) Appl. No.: 15/077,250

(22) Filed: Mar. 22, 2016

(51) Int. Cl. B31F 1/22; D21H 27/02

(52) U.S. Cl. CPC B31F 1/225; D21H 27/02

(57) ABSTRACT

A system and method for inducing fluting in paper aligned in a machine direction of the paper while the paper is being fed through the board-making machine in the machine direction. In an embodiment, a method of producing the medium for a board product includes unwinding paper from a paper roll in a machine direction that is naturally aligned with the machine direction of the paper. Then, an embossing or scoring stage embosses or scores the paper with fluting that is also aligned with the machine direction of the paper. The resultant fluted paper has flutes that are aligned with underlying fibers of the paper, thereby taking advantage of the natural strength of the aligned fibers in the machine direction of the paper. Further, embossing or scoring paper for fluting greatly reduces take-up when such a fluted medium is compared to a facing that may be combined with the fluting to yield a board product. Further, maximum combined board strength is realized when all underlying fibers of all participating papers are aligned in MD and flute direction.

### BACKGROUND

Modern paper-making techniques use paper machines at paper mills to produce rolls of paper that can, in turn, be used by board makers to produce board products (i.e., corrugated board). As a result, rolls of paper may be produced from machines that operate continuously. Modern paper machines typically produce paper from a number of substances including wood pulp that comprise wood fibers (although other fibers may also be used). These fibers tend to be elongated and suitable to be aligned next to one another. The fiber starts as a slurry that can be fed onto a moving screen from a head box of the paper machine. In modern paper machines, the fibers tend to align with each other and align with a direction in which the screen is moving. This alignment direction of underlying fibers is called the major direction of the paper and is in line with the machine direction. Thus, the major direction is often simply called the machine direction (MD) and the paper that is produced has an associated MD value.

Therefore, when paper is wound at the end of the papermaking process, the roll is paper wound up in the machine direction. Because of the alignment of underlying fibers in the machine direction of the paper, the paper itself exhibits greater strength in the machine direction when compared to a cross direction (CD) that is perpendicular to the machine direction. That is, the paper may bend, fold, or deform more easily in a cross direction as compared to the machine direction because the CD value is less than the MD value.

When paper is used to make a board product, portions of the paper used for the board product may be corrugated. Traditional corrugating machines will corrugate the underlying paper product in the cross direction of the paper thereby failing to take advantage of the natural strength bias of the paper in the machine direction. In an effort to increase the cross direction strength (at the expense of strength in the machine direction), paper makers have sought solutions that attempt to disrupt the natural alignment of fibers when fed to the initial screen at the head box of a paper machine. Such solutions, however, lead to slower paper machine operating speeds and a decrease in paper machine efficiency. As a result, papermaking efficiency is sacrificed for greater paper strength in the cross direction because of traditional corrugating techniques. Further, the greater natural strength qualities of paper in the machine direction is left unharnessed by cross corrugation techniques in board making solutions.

### BRIEF DESCRIPTION OF THE DRAWINGS

Aspects and many of the attendant advantages of the claims will become more readily appreciated as the same become better understood by reference to the following detailed description, when taken in conjunction with the accompanying drawings, wherein:

FIG. 1 is a diagram of aspects of a machine for feeding paper into a conventional corrugating stage.

FIG. 2 is a diagram of a portion of resultant corrugated paper product that results from the conventional corrugating roll of FIG. 1.

FIG. 3 is a diagram of aspects of a machine for feeding paper into an embossing stage in a machine direction according to an embodiment of the subject matter disclosed herein.

FIG. 4 is a diagram of a portion of a resultant fluted paper product that results from the embossing roll of FIG. 3 according to an embodiment of the subject matter disclosed herein.

FIG. 5 is a diagram of aspects of a machine for feeding paper into a scoring stage in a machine direction according to an embodiment of the subject matter disclosed herein.

FIG. 6 is a diagram of a portion of a resultant scored paper product that results from the scoring roll of FIG. 5 according to an embodiment of the subject matter disclosed herein.

### DETAILED DESCRIPTION

The following discussion is presented to enable a person skilled in the art to make and use the subject matter disclosed herein. The general principles described herein may be applied to embodiments and applications other than those detailed above without departing from the spirit and scope of the present detailed description. The present disclosure is not intended to be limited to the embodiments shown, but is to be accorded the widest scope consistent with the principles and features disclosed or suggested herein.

By way of overview, the subject matter disclosed herein may be directed to a system and method for inducing fluting in paper in a machine direction of the paper. In a conventional board-making manufacturing setting, rolls of paper may be unwound in a machine direction and then corrugated in the cross-direction. Corrugating in the cross direction fails to take advantage of the MD value of the paper. Inducing fluting through embossing or scoring in the same direction as the underlying fibers (e.g., the machine direction) of the paper employs the natural strength in the machine direction of the paper used to create the fluted medium in a board product.

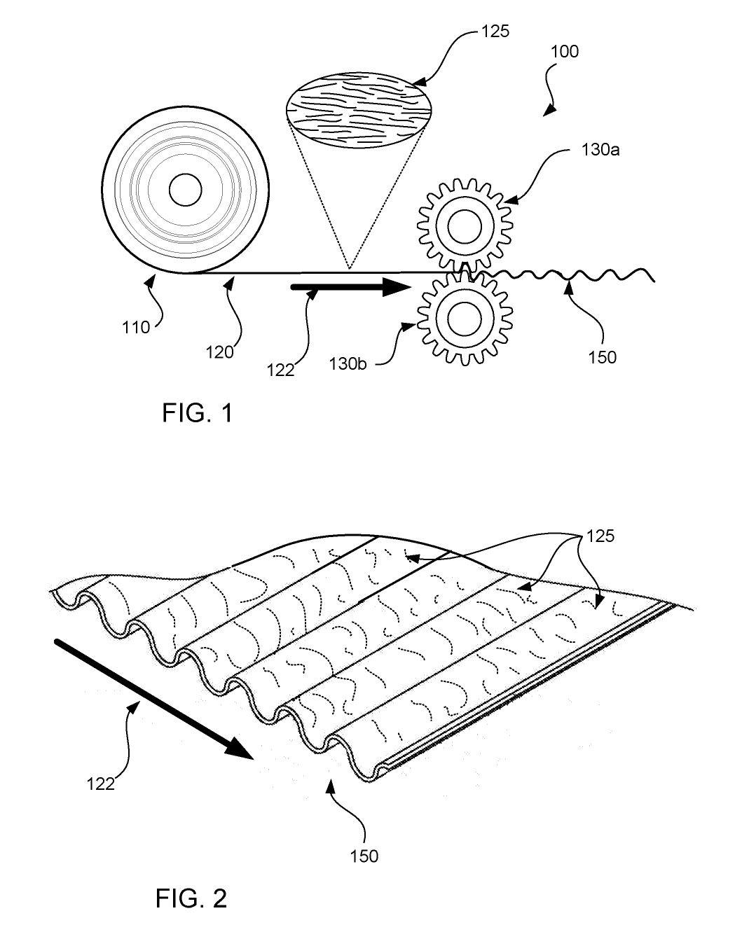

In one embodiment, a method of producing the fluting for a board product includes unwinding paper from a paper roll in a machine direction. Then, an embossing or scoring stage embosses or scores the paper to induce fluting. The induced fluting is also aligned with the machine direction of the paper thereby having the fluting aligned with higher MD value (as compared to the CD value). Further, linear embossing or scoring paper for fluting greatly reduces take-up compared with conventional corrugating. These and other aspects will become apparent in the detailed description of the embodiments as discussed below with respect to FIGS. 1-6.

FIG. 1 is a diagram of aspects of a machine 100 for feeding paper into conventional corrugating rolls. Of course, conventional corrugating machine will have a number of additional aspects and parts, but for the purposes of this discussion, only these portions depicted in FIG. 1 are needed. In this diagram, a roll of paper 110 may be unwound from a feed roll such that a leading edge of paper 120 may be fed in a first direction 122 toward machinery suited to shape, cut, mold, combine, or otherwise change the paper 110 into a new product. In FIG. 1, only a corrugating stage is shown for simplicity. Thus, as paper 120 is unwound from the paper roll 110, the paper 120 propagates in the first direction 122.

The paper 120 in FIG. 1 may be fed into a corrugator that includes a first corrugating roll 130a that is aligned to work in concert with a second corrugating roll 130b. Thus, as paper 120 is fed between the first and second corrugating rolls 130a and 130b, ribs from the corrugating rolls form the paper into a desired fluted shape. That is, the paper 120 forms around the ribs of the first corrugating roll 130a and the second corrugating roll in a meshed sequence resulting in corrugated paper. The resultant product is a fluted paper 150 exhibiting a shape that resembles the shape of the ribs of each corrugating roll 130a and 130b. The fluted paper 150 may then be referred to as a corrugated medium and may be used in conjunction with additional papers to form a corrugated board having one or more corrugated mediums glued to one or more facings.

One problem with corrugating paper for use in corrugated board making is that the paper needed for the fluted medium is much greater than the paper needed for the facing. This is obvious in so much as the overall length of the paper run, when formed and folded around corrugating ribs becomes a longer path than simply the flat facing portion of the corrugated board product. This lineal difference is often referred to as “take-up factor”. Depending on the size of the fluting, the take-up factor may be rather high (for example, 43% for a common C-flute profile). The fluted paper 150 is manufactured on corrugating machines 100 of FIG. 1 at speeds up to 1500 feet per minute.

Paper is produced at paper mills dedicated solely to producing paper on rolls. Then, the paper rolls are shipped to a board-making plants where a machine (portions of which are shown as machine 100 in FIG. 1) may be located. As the papermaking process is accomplished by a papermaking entity and board products are produced by a different entity, many times the interests of each entity are not aligned.

One example of misaligned interests includes the method and machine at a paper mill that produce the underlying paper 120. As shown in the exploded section of FIG. 1, underlying fibers 125 of the paper tend to be elongated and aligned with respect to each other in machine direction 122. As the speed of a paper machine is increased, the slurry is quickly fed out of a head box, the natural tendency of the underlying fibers is to further align along the machine direction of the paper machine. This results in a final paper product that has most underlying fibers aligned in the machine direction. As is discussed further below, board makers may have an interest in having highly misaligned fibers in the paper (e.g., fibers laid out in all direction irrespective of machine direction). Prior to discussing reasons why, further aspects of the papermaking process are discussed.

As has been discussed, the machine direction of the paper 120 exhibits greater strength characteristics (MD value) as well as greater resistance to bending when compared to the cross direction of the paper (CD value). This is mostly due to the nature of papermaking causing the underlying fibers to align in the machine direction. Of course, when the paper roll 110 is then unwound at a next manufacturing stage, as is shown in FIG. 1, the machine direction of the paper 120 remains aligned with the machine direction 122 of the corrugating process.

In the machine 100 of FIG. 1, the corrugating rolls 130a and 130b corrugate the paper in the cross direction of the paper 120. That is, the corrugating of the paper 120 is not linear with respect to the machine direction 122 and any resultant flutes have a direction perpendicular to both the corrugating machine direction 122 and the machine direction of the paper 120. This is shown in greater detail with respect to FIG. 2.

FIG. 2 is a diagram of a portion of a resultant corrugated paper product 150 that results from the conventional corrugating machine 100 of FIG. 1. This diagram shows an isometric view of a portion of the fluted paper 150. The machine direction 122 is shown in FIG. 2 and is perpendicular to the flute direction as the flutes are in the cross direction of the paper. As is shown, the underlying fibers 125 remain aligned in the machine direction of the paper, which is also aligned with the corrugating machine direction 122. However, the flutes are formed perpendicular to most underlying fibers 125. This results in flutings that are not aligned with fibers and therefore do not take advantage of the natural strength of the MD value of the paper (when compared to the CD value). Such a failure to harness the MD value of the paper leads to inefficiencies on the manufacturing of board products when a specific board strength is to be realized. That is, it will necessarily take more paper (heavier paper, larger flutes, and the like) to realize the required board strength.

In an effort to increase CD values in paper (for the specific purposes of board making), paper-makers may be required to intentionally try to misalign underlying fibers in an effort to make the paper product stronger in the cross direction. This may result in less strength in the machine direction, but eventually leads to greater strength in the finished board product or box product as the paper product is corrugated in the cross direction. Intentionally misaligned the underlying fibers are, many times, achieved through agitation at head box on paper machines but at the expense of paper machine speed.

Thus, board-makers have an interest in a paper product that has a greater CD value because corrugators will corrugate in the cross direction. However, paper makers have an interest in producing paper with underlying fibers aligned in the machine direction (e.g., a greater MD value) as such an alignment requires less complex equipment and allows paper machines to operate at greater speeds. This misaligned interest then leads to compromising the efficiency of the paper maker or the products of the board maker; this is all because of cross corrugation. The remainder of the disclosure discusses linear embossing or linear scoring techniques that realign this interest.

FIG. 3 is a diagram of aspects of a machine 200 for feeding paper into an embossing stage in a machine direction according to an embodiment of the subject matter disclosed herein. In this embodiment, a paper roll 110 may be unwound such that paper 120 is fed into a pair of embossing rolls 230a and 230b in an embossing stage. The embossing rolls 230a and 230b include ribs that are aligned with the machine direction 122 as shown in the exploded box of FIG. 3. That is, the grooves and valleys of the embossing rolls 230a and 230b will induce fluting in the machine direction 122, which is also aligned with the greater MD value of the paper 120. Further, the embossing stage may have additional features including portions suited to condition the paper, such as a heating, wetting or moisturizing section. These and other additional aspects of creating a linear embossed fluting are not discussed further herein for brevity.

Embossing is a process that stretches and deforms the paper going through the embossing rolls 230a and 230b. As the paper 120 is squeezed through an embossing roll 230a that is closely aligned with a counterpart embossing roll 230b, the paper 120 tends to stretch away from the contact points between the embossing rolls 230a and 230b. The resultant embossed paper 250 now has a width that is greater due to the stretching of the paper in the lateral direction. But, the embossed paper 250 now includes fluting such the original width of the pre-embossed paper 120 is almost equivalent to the width of the resultant fluted medium. Further, the length of the paper 120 (as defined by the machine direction of the paper 120) also remains unaffected by the embossing process.

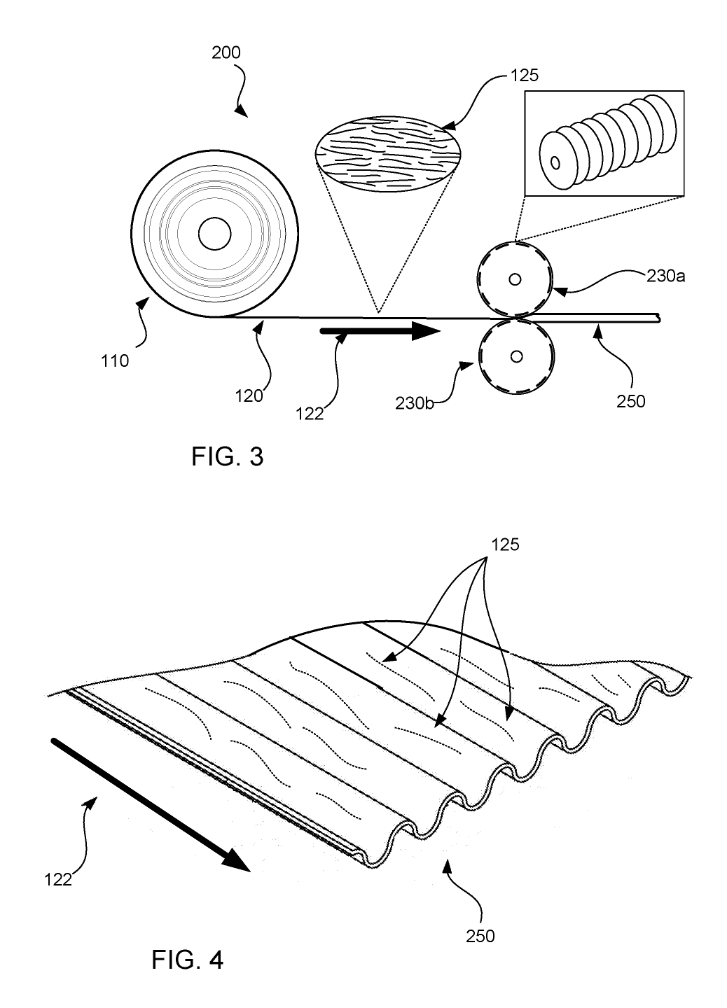

As will be discussed further in FIG. 4 below, the embossing process results in almost no take-up factor, and in some applications, zero take-up factor. This is because the flutes are not simply formed around corrugating ribs, but are actually stretched to result in a desired pattern. The embossed pattern then yields a fluted pattern similar to corrugating. Therefore, inducing fluting through embossing leads to a large increase in efficiency (e.g., reduction in take-up factor by as much as 43% in the case of a C-flute profile) while also taking advantage of the MD value of the paper that makes up the fluted medium 250.

In the embodiment of FIG. 3, the grooves and valleys of the embossing rolls 230a and 230b are curvilinear such that a sinusoidal flute may be induced. Other embodiments may include a triangular pattern, saw-tooth pattern, semi-rectangular pattern, or any other embossing pattern whereby some form of fluting is induced in the underlying paper 120 being fed through the embossing rolls 230a and 230b. In other embodiments, only one of the embossing rolls may have a specific flute inducing shape while a counterpart roll may be flat (not shown). In still further embodiments, the machine 200 may include additional embossing rolls (not shown) for second and third embossing stages in an effort to induce or enhance a desired fluting.

FIG. 4 is a diagram of a portion of a resultant fluted paper product 250 that results from the embossing stage of FIG. 3 according to an embodiment of the subject matter disclosed herein. As has been discussed with respect to FIG. 3, the induced flutes are congruent with the machine direction 122. Thus, the underlying long fibers 125 of the paper remain aligned with the flute direction. Having the underlying long fibers aligned with the fluting results in an alignment of the fluting with the greater MD value of the paper (when compared to the CD value). As the cross corrugating techniques of the machine 100 of FIG. 1 would necessarily have corrugations aligned with the CD value of the paper, the linear embossing process using the machine 200 of FIG. 3 takes advantage of the MD value of the paper by aligning the flutes in the machine direction. Therefore, the flute-inducing embossing process of the machine 200 of FIG. 3 allows for less total fiber to be used in achieving a specific strength of corrugated board.

Such a linear embossing system and method leads to efficiencies on several levels and succeeds in realigning the interests of paper makers and board/box makers. First, linear embossing allows the paper maker to disregard any need to carefully control the alignment (or rather non-alignment) of the pulp fibers when first poured onto a screen on a paper machine. Recall that in order to improve strength in the cross direction, paper machines may include a head box that attempted to combat the natural alignment of underlying long fibers in the machine direction. With linear embossing, the need for improved strength in the cross direction is reduced or eliminated. Therefore, the paper-maker can focus on improving the speed of the paper machine.

Second, board makers can produce board products with less paper material. The linear embossing systems and methods discussed herein lead to a fluted medium that requires less material for production. That is, in conventional corrugating machines, the paper needed for the fluted medium is greater than the paper needed for a facing portion (in linear terms). Thus, the efficiency gain is two-fold: less overall paper used in making corrugated board and greater strength in the resultant board by aligning the MD value in both fluting and facings.

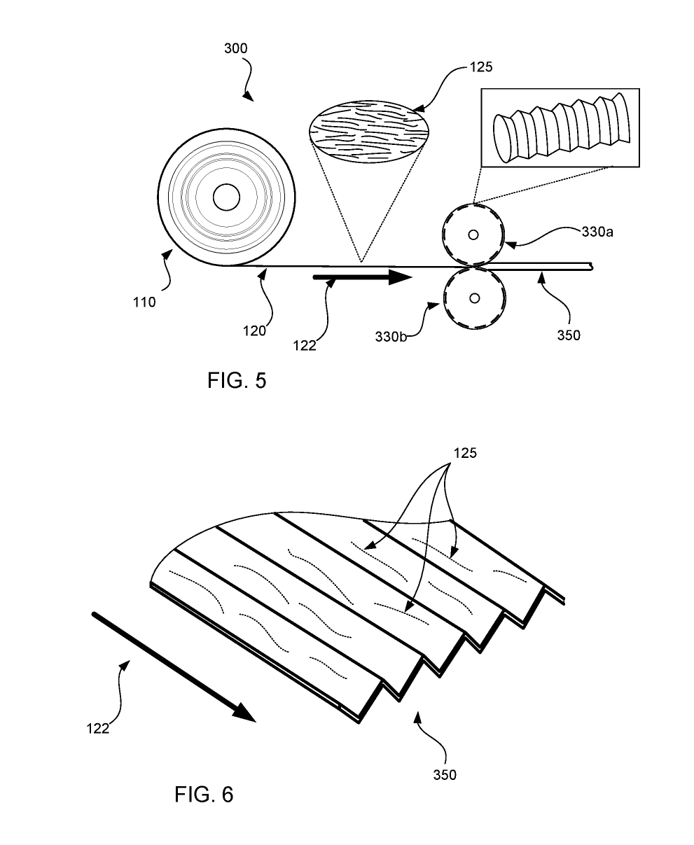

The embodiments as discussed with respect to FIGS. 3 and 4 have an embossing stage that induces a sinusoidal shape of a flute. However, other embodiments may include different shapes for embossing rolls, (such as triangular, saw-tooth, and the like) or even simply a scoring stage. The embodiments as discussed with respect to FIGS. 5 and 6 are an example of fluting that is shaped or formed from a process other than the sinusoidal shape of the embodiments discussed with respect to FIGS. 3 and 4.

FIG. 5 is a diagram of a portion of a machine for feeding paper into a scoring stage in a machine direction according to an embodiment of the subject matter disclosed herein. In this embodiment, a paper roll 110 may be unwound such that paper 120 is fed into a pair of scoring rolls 330a and 330b in a scoring stage. The scoring rolls 330a and 330b include ribs that are aligned with the machine direction 122 as shown in the exploded box of FIG. 5. That is, the grooves and valleys of the scoring rolls 330a and 330b will induce scoring lines that lead to fluting in the machine direction 122, which is also aligned with the machine direction of the paper 120.

Similar to embossing, scoring is a process that stretches or deforms the paper going through the scoring rolls 330a and 330b. As a portion of the paper 120 is squeezed through a scoring roll 330a that is closely aligned with a counterpart scoring roll 330b, the paper 120 tends to stretch out away from the scoring point.

The resultant scored paper 350 now has a width that is greater due to the stretching of the paper in a lateral direction. But, the scored paper 350 now includes fluting such the original width of the pre-scored paper 120 is almost equivalent to the width of the resultant fluted medium. Further, the length of the paper 120 (as defined by the machine direction of the paper 120) also remains unaffected by the scoring process. As before, with respect to embossing, the scoring process results in almost no take-up factor. This is because the flutes are not simply formed around corrugating ribs, but are actually stretched to result in a desired pattern. The scored pattern then yields a fluted pattern similar to corrugating. Therefore, inducing fluting through scoring leads to an increase in efficiency while also taking advantage of the MD value of the paper that makes up the fluted medium 350.

FIG. 6 is a diagram of a portion of resultant scored paper product that results from the scoring roll of FIG. 5 according to an embodiment of the subject matter disclosed herein. In FIG. 6, the induced shape change from flat paper is shown in a bit of an exaggerated manner whereby the scoring leads to a distinct triangular shape of flutes. Such a distinct triangular pattern may be more noticeable with a triangular-toothed embossing stage, but the concept remains the same. Scoring induced by scoring rolls 330a and 330b cause induced fluting in the machine direction of the paper that is aligned with the corrugating machine direction 122 as well as the elongated fibers 125 of the paper itself.

While the subject matter discussed herein is susceptible to various modifications and alternative constructions, certain illustrated embodiments thereof are shown in the drawings and have been described above in detail. It should be understood, however, that there is no intention to limit the claims to the specific forms disclosed, but on the contrary, the intention is to cover all modifications, alternative constructions, and equivalents falling within the spirit and scope of the claims.

What is claimed is:

1. A method for making a paper product with improved efficiency, the method comprising:
unwinding paper from a roll of paper in a first direction;
feeding the unwound paper into one or more pairs of embossing rolls in the first direction; and
inducing flutes in the paper in the first direction.

2. The method of claim 1, further comprising stretching the paper when inducing the flutes in the paper.

3. The method of claim 1, further comprising combining the fluted paper with one or more additional paper products to form a board product.

4. The method of claim 1, further comprising:
feeding the fluted paper into a cutting machine in the first direction; and
cutting the fluted paper at one or more intervals.

5. The method of claim 1, further comprising:
feeding the fluted paper into a gluing machine in the first direction; and
gluing the fluted paper to one or more facings.

6. The method of claim 1, further comprising:
feeding the fluted paper into a board-making machine in the first direction;
feeding a non-fluted paper into the board-making machine in concert with the fluted paper; and
producing a board product that results in zero take-up of the fluted paper with respect to the non-fluted paper.

7. The method of claim 1, wherein the paper unwound from the paper roll comprises a fiber pattern having an MD value greater than a CD value.

8. The method of claim 1, wherein the first direction comprises a machine direction.

9. The method of claim 1, wherein the first direction comprises a machine direction of the paper with respect to underlying aligned fibers.

10. A method for making a paper product with improved efficiency, the method comprising:
unwinding paper from a roll of paper in a first direction;
feeding the unwound paper into a one or more pairs of scoring rolls in the first direction; and
scoring in the paper in the first direction.

11. The method of claim 10, further comprising stretching the paper when scoring in the paper.

12. The method of claim 10, further comprising combining the scored paper with one or more additional paper products to form a board product.

13. The method of claim 10, further comprising:
feeding the scored paper into a board-making machine in the first direction;
feeding a non-scored paper into the board-making machine in concert with the scored paper; and
producing a board product that results in zero take-up of the scored paper with respect to the non-scored paper product.

14. The method of claim 10, wherein the paper unwound from the paper roll comprises a fiber pattern having a fiber pattern having an MD value greater than a CD value.

15. The method of claim 10, wherein the first direction comprises a machine direction.

16. The method of claim 10, wherein the first direction comprises a machine direction of the paper with respect to underlying aligned fibers.

17. A machine, comprising:
a paper feed roll configured to feed paper to a subsequent stage in a machine direction; and
a flute inducing stage configured to receive the paper in the machine direction and configured to induce fluting in the paper in the machine direction.

18. The machine of claim 17, wherein the flute inducing stage further comprises a pair of embossing rolls configured to induce a sinusoidal fluting in the paper fed to the flute inducing stage.

19. The machine of claim 17, wherein the flute inducing stage further comprises a pair of embossing rolls configured to induce a triangular fluting in the paper fed to the flute inducing stage.

20. The machine of claim 17, wherein the flute inducing stage further comprises a pair of scoring rolls configured to induce a scored fluting in the paper fed to the flute inducing stage.
